(19) United States
(12) Patent Application Publication
(10) Pub. No.: US 2024/0282931 A1
(43) Pub. Date: Aug. 22, 2024

(54) COATED ELECTRODE ACTIVE MATERIAL PARTICLES FOR LITHIUM-ION BATTERIES, ELECTRODE FOR LITHIUM-ION BATTERIES, AND PRODUCTION METHOD OF COATED ELECTRODE ACTIVE MATERIAL PARTICLES FOR LITHIUM-ION BATTERIES

(71) Applicant: APB CORPORATION, Chiyoda-ku Tokyo (JP)

(72) Inventors: Toshiaki YAMAGUCHI, Kyoto-shi Kyoto (JP); Kenichi KAWAKITA, Kyoto-shi Kyoto (JP); Hideaki HORIE, Chiyoda-ku Tokyo (JP)

(21) Appl. No.: 18/567,678

(22) PCT Filed: Jun. 13, 2022
(86) PCT No.: PCT/JP22/23610

§ 371 Date: Dec. 6, 2023

(30) Foreign Application Priority Data
Jun. 11, 2021 (JP) 2021-098128
Jul. 16, 2021 (JP) 2021-118045

(51) Int. Cl. H01M 4/36; H01M 4/02; H01M 4/62; H01M 10/0525

(52) U.S. Cl. CPC H01M 4/366; H01M 4/622; H01M 4/624; H01M 10/0525; H01M 2004/021

(57) ABSTRACT

Coated electrode active material particles for lithium-ion batteries that can suppress side reactions between the electrolytic solution and the coated electrode active material particles, and that can prevent the internal resistance value of the lithium-ion battery from increasing even when they are used in a high temperature environment, can be provided. Coated electrode active material particles for lithium-ion batteries in which at least a part of the surface of the electrode active material particles is coated with a coating layer, wherein the coating layer contains particles made of polymer having lithium-ion conductivity, a coating resin, and a conductive assistant.

### FIELD OF THE INVENTION

This invention relates to coated electrode active material particles for lithium-ion batteries, an electrode for lithium-ion batteries, and a production method of coated electrode active material particles for lithium-ion batteries.

Lithium-ion batteries have come to be widely used in a variety of usages as secondary batteries that can achieve high energy density and high power density.

For example, a coated active material is disclosed in Patent reference 1, wherein the coated active material contains a resin composition for coated active material, which is a polymer of a monomer composition comprising an ester compound having a monovalent aliphatic alcohol with 1 to 12 carbon atoms and (meth)acrylic acid and an anionic monomer and a polymer with an acid value of 30 to 700, and wherein the coated active material has a coating layer containing the resin composition for coating active material on at least a part of the surface of the active material.

### CITATION LIST

### Patent Literature

[Patent Reference 1] Japanese Unexamined Patent Application Publication No. 2017-160294

### BRIEF SUMMARY OF THE INVENTION

### Problems that Invention is to Solve

Lithium-ion batteries have become widely used in various purposes and are sometimes used in high-temperature environments, and the like. In terms of conventional lithium-ion batteries using coated active materials, when they are used in high-temperature environments, there was a problem that side reactions occurred between the electrolytic solution and the coated active materials, causing deterioration of the lithium-ion batteries (specifically, internal resistance value may increase). Therefore, there was room for improvement.

The present invention has an objective to provide coated electrode active material particles for lithium-ion batteries that can suppress side reactions between the electrolytic solution and the coated electrode active materials, and that can prevent the internal resistance value of lithium-ion batteries from increasing even when they are used in a high temperature environment. The present invention also has an objective to provide an electrode for lithium-ion batteries having the coated electrode active material particles for lithium-ion batteries, and a production method of the coated electrode active material particles for lithium-ion batteries.

### Means to Solve the Problems

As a result of intensive studies to solve the above problems, the inventors have found that the accumulation of reaction products (SEI: Solid Electrolyte Interphase) generated by direct contact between electrode active material particles and electrolytic solution is a factor of increasing the internal resistance value of the lithium-ion battery. As for coated electrode active material particles for lithium-ion batteries in which at least a part of the surface of the electrode active material particles is coated with a coating layer, the present inventors have considered preventing the contact between the electrode active material particles and the electrolytic solution by using the coating resin constituting the coating layer, thereby suppressing side reactions that occur between the electrolytic solution and the coated electrode active material particles. However, it was not possible to sufficiently prevent the internal resistance value of lithium-ion batteries from increasing. As a result of further intensive studies in order to solve the above problems, the present inventors have discovered that side reactions occurring between the electrolytic solution and the coated electrode active material particles can be suppressed, and an increase in internal resistance of lithium-ion batteries can be effectively reduced by using the coating layer containing particles made of polymer having lithium-ion conductivity, coating resin, and conductive assistant. This discovery has led to this invention.

In other word, this invention related to: coated electrode active material particles for lithium-ion batteries in which at least a part of the surface of the electrode active material particles is coated with a coating layer, wherein the coating layer contains particles made of polymer having lithium-ion conductivity, a coating resin, and a conductive assistant; an electrode for lithium-ion batteries comprising an electrode active material layer containing the coated electrode active material particles for lithium-ion batteries and an electrolytic solution containing an electrolyte and a solvent, wherein the weight proportion of a coating resin contained in the electrode for lithium-ion batteries is 1 to 10 wt % based on the weight of the electrode for lithium-ion batteries; and a production method of coated electrode active material particles for lithium-ion batteries, wherein the coated electrode active material particles for lithium-ion batteries are mentioned above, the production method including a step of removing a solvent after mixing electrode active material particles, particles made of polymer having lithium-ion conductivity, a coating resin, a conductive assistant, and an organic solvent.

### Effects of the Invention

According to this invention, coated electrode active material particles for lithium-ion batteries, that can suppress side reactions between the electrolytic solution and the coated electrode active material particles, and that can prevent the internal resistance value of the lithium-ion battery from increasing even when they are used in a high temperature environment, can be provided.

### DESCRIPTION OF EMBODIMENTS

### <Coated Electrode Active Material Particles for Lithium-Ion Batteries>

The coated electrode active material particles for lithium-ion batteries of this invention are coated electrode active material particles for lithium-ion batteries in which at least a part of the surface of the electrode active material particles is coated with a coating layer, wherein the coating layer contains particles made of polymer having lithium-ion conductivity, a coating resin, and a conductive assistant. With this configuration, this invention can avoid contact between the electrode active material particles and the electrolytic solution, and can suppress side reactions between the electrolytic solution and the coated electrode active material particles, and can prevent the internal resistance value of lithium-ion batteries from increasing.

### (Electrode Active Material)

The electrode active material particles include cathode active material particles and anode active material particles. The appropriate particles will be selected depending on whether the coated electrode active material particles for lithium-ion batteries of this invention are used as coating cathode active material particles or coating anode active material particles.

The cathode active material particle includes a composite oxide of lithium and a transition metal {a composite oxido having one kind of transition metal (LiCoO₂, LiNiO₂, LiAlMnO₄, LiMnO₂, LiMn₂C₄, or the like), a composite oxide having two kinds of transition metal elements (for example, LiFeMnO4, LiNi₁₋ₓCoₓO₂, LiMn_{1-y}Co_{y}O₂, LiNi_{1/3}Co_{1/3}Al_{1/3}O₂, and LiNi_{0.8}Co_{0.15}Al_{0.05}O₂), a composite oxide having three or more kinds of metal elements [for example, LiMₐM′_{b}M″_{c}O₂ (where M, M′, and M″ are transition metal elements different each other and satisfy a+b+c=1, and one example is LiNi_{1/3}Mn_{1/3}Co_{1/3}O₂)], or the like}, a lithium-containing transition metal phosphate (for example, LiFePO₄, LiCoPO₄, LiMnPO₄, or LiNiPO₄), a transition metal oxide (for example, MnO₂ and V₂O₅), a transition metal sulfide (for example, MoS₂ or TiS₂), and a conductive macromolecule (for example, polyaniline, polypyrrole, polythiophene, polyacetylene, poly-p-phenylene, or polyvinyl carbazole). Also, these cathode active material particles may be used alone. Two or more thereof may be used in combination. Herein, the lithium-containing transition metal phosphate may have some of the transition metal sites replaced with other transition metals.

The volume average particle size of the cathode active material particles is preferably from 0.01 to 100 μm, more preferably from 0.1 to 35 μm, and even more preferably from 2 to 30 μm, from the viewpoint of electrical characteristics of the battery.

Examples of the anode active material include a carbon-based material (graphite, non-graphitizable carbon, amorphous carbon, a resin sintered product (for example, a sintered product obtained by sintering and carbonizing a phenol resin, a furan resin, or the like), cokes (for example, a pitch coke, a needle coke, and a petroleum coke), a carbon fiber, or the like), a silicon-based material [silicon, silicon oxide (SiOx), a silicon-carbon composite body (a composite body obtained by coating surfaces of carbon particles with silicon and/or silicon carbide, a composite body obtained by coating surfaces of silicon particles or silicon oxide particles with carbon and/or silicon carbide, silicon carbide, or the like), a silicon alloy (a silicon-aluminum alloy, a silicon-lithium alloy, a silicon-nickel alloy, a silicon-iron alloy, a silicon-titanium alloy, a silicon-manganese alloy, a silicon-copper alloy, a silicon-tin alloy, or the like), or the like], a conductive macromolecule (for example, polyacetylene or polypyrrole), a metal (tin, aluminum, zirconium, titanium, or the like), a metal oxide (a titanium oxide, a lithium-titanium oxide, or the like), a metal alloy (for example, a lithium-tin alloy, a lithium-aluminum alloy, or a lithium-aluminum-manganese alloy), or the like, and a mixture of the above and a carbon-based material. These anode active material particles may be used alone. Two or more thereof may be used in combination.

The volume average particle size of the anode active material particles is preferably 0.01 to 100 μm, more preferably 0.1 to 20 pam, and even more preferably 2 to 10 μm, from the viewpoint of the electrical characteristics of the battery.

At least a part of the surface of the electrode active material particles is covered with a coating layer, and the coating layer contains particles made of polymer having lithium-ion conductivity, a coating resin, and a conductive assistant.

### (Particles Made of Polymer Having Lithium-Ion Conductivity)

Examples of the particles made of polymer having lithium-ion conductivity are the particles made of polymers such as polyethylene oxide (PEO), polyacrylonitrile (PAN), polyethylene glycol (PEG), polymethyl methacrylate (PMMA), LiPON, Li₃N, LixLa₁₋ₓTiO₃(0<x<1) and Li₂S—GeS—Ga₂S₃. In particular, in terms of suitably suppressing side reactions between the electrolytic solution and the coated electrode active material particles and suitably reducing the increase in internal resistance value of lithium-ion batteries, preferably, it is one or more selected from the group consisting of polyethylene oxide (PEO), polyacrylonitrile (PAN), and polyethylene glycol (PEG).

As for the particles made of polymer having lithium-ion conductivity, the volume average particle size is preferably 1 to 50 μm. Because the volume average particle size of the particles made of polymer having lithium-ion conductivity is within the above range, contact between the electrode active material particles and the electrolytic solution can be suitably suppressed. The volume average particle size of the particles made of polymer having lithium-ion conductivity is more preferably 5 to 40 μm. In this specification, the volume average particle size means the particle size is 50% based on a cumulative volume calculated from the small diameter side in the particle size distribution obtained by the laser diffraction method.

The particles made of polymer having lithium-ion conductivity may be pulverized, crushed, etc., and then classified to have a volume average particle size within the above range. The method of pulverizing, crushing, etc. is not particularly limited, and any known method (high-speed disperser, bead mill, ball mill, etc.) can be appropriately selected and used. Further, the classification method is not particularly limited, and any known method such as using a multistage sieve can be appropriately selected and used.

The weight proportion of the particles made of polymer having lithium-ion conductivity is preferably 0.1 to 5 wt % based on the weight of the coated electrode active material particles. When the weight ratio of the particles made of polymer having lithium-ion conductivity is within the above range, contact between the electrode active material particles and the electrolytic solution can be suitably suppressed. The weight ratio of the particles made of polymer having lithium-ion conductivity is more preferably 0.5 to 4.5 wt %, based on the weight of the coated electrode active material particles, and is more preferably 1.0 to 4.0 wt %.

### (Coating Resin)

The coating resin is preferably a resin containing a polymer having the acrylic monomer (a) as an essential constituent monomer and the like. Specifically, the coating resin is preferably a polymer of a monomer composition containing acrylic acid (a0) as the acrylic monomer (a). In terms of the above monomer composition, from the point of flexibility of the coating layer, the content of acrylic acid (a0) is preferably 90 wt % or more and 95 wt % or less based on the weight of the entire monomer.

The coating resin may contain, as the acrylic monomer (a), a monomer (a1) having a carboxyl group other than acrylic acid (a0) or an acid anhydride group.

Examples of the monomer (a1) having a carboxyl group or an acid anhydride group other than acrylic acid (a0) include methacrylic acid, crotonic acid, monocarboxylic acids having 3 to 15 carbon atoms of cinnamic acid and the like, (anhydrous) maleic acid, fumaric acid, (anhydrous) itaconic acid, citraconic acid, dicarboxylic acids with 4 to 24 carbon atoms such as mesaconic acid, and polycarboxylic acid having 6 to 24 carbon atoms such as aconitic acid with trivalent to tetravalent or higher valence.

The coating resin may contain a monomer (a2) represented by the following formula (1) as the acrylic monomer (a).

$$C {H}_{2} = C ( {R}^{1} ) {COOR}^{2} \qquad ( 1 )$$

[In formula (1), R¹ is a hydrogen atom or a methyl group, and R² is a straight chain having 4 to 12 carbon atoms or a branched alkyl group having 3 to 36 carbon atoms.]

In terms of the monomer (a2) shown in formula (1), R¹ represents a hydrogen atom or a methyl group. Preferably, R¹ is a methyl group.

R² is preferably a straight chain or branched alkyl group having 4 to 12 carbon atoms, or a branched alkyl group having 13 to 36 carbon atoms.

(a21) Ester compound in which R² is a straight chain or branched alkyl group having 4 to 12 carbon atoms

Examples of the straight chain alkyl group having 4 to 12 carbon atoms include butyl group, pentyl group, hexyl group, heptyl group, octyl group, nonyl group, decyl group, undecyl group, and dodecyl group.

Examples of branched alkyl groups having 4 to 12 carbon atoms include 1-methylpropyl group (sec-butyl group), 2-methylpropyl group, 1,1-dimethylethyl group (tert-butyl group), 1-methylbutyl group, 1-dimethylpropyl group, 1,2-dimethylpropyl group, 2,2-dimethylpropyl group (neopentyl group), 1-methylpentyl group, 2-methylpentyl group, 3-methylpentyl group, 4-methylpentyl group, 1,1-dimethylbutyl group, 1,2-dimethylbutyl group, 1,3-dimethylbutyl group, 2,2-dimethylbutyl group, 2,3-dimethylbutyl group, 1-ethylbutyl group, 2-ethylbutyl group, 1-methylhexyl group, 2-methylhexyl group, 2-methylhexyl group, 4-methylhexyl group, 5-methylhexyl group, 1-ethylpentyl group, 2-ethylpentyl group, 3-ethylpentyl group, 1, 1-dimethylpentyl group, 1,2-dimethylpentyl group, 1,3-dimethylpentyl group, 2,2-dimethylpentyl group, 2,3-dimethylpentyl group, 2-ethylpentyl group, 1-methylheptyl group, 2-methylheptyl group, 3-methylheptyl group, 4-methylheptyl group, 5-methylheptyl group, 6-methylheptyl group, 1,1-dimethylhexyl group, 1,2-dimethylhexyl group, 1,3-dimethylhexyl group, 1,4-dimethylhexyl group, 1,5-dimethylhexyl group, 1-ethylhexyl group, 2-ethylhexyl group, 1-methyloctyl group, 2-methyloctyl group, 3-methyloctyl group, 4-Methyloctyl group, 5-methyloctyl group, 6-methyloctyl group, 7-methyloctyl group, 1,1-dimethylheptyl group, 1,2-dimethylheptyl group, 1,3-dimethylheptyl group, 1,4-dimethylheptyl group, 1,5-dimethylheptyl group, 1,6-dimethylheptyl group, 1-ethylheptyl group, 2-ethylheptyl group, 1-methylnonyl group, 2-methylnonyl group, 3-methylnonyl group, 4-Methylnonyl group, 5-methylnonyl group, 6-methylnonyl group, 7-methylnonyl group, 8-methylnonyl group, 1,1-dimethyloctyl group, 1,2-dimethyloctyl group, 1,3-dimethyloctyl group, 1,4-dimethyloctyl group, 1,5-dimethyloctyl group, 1,6-dimethyloctyl group, 1,7-dimethyloctyl group, 1-ethyloctyl group, 2-ethyloctyl group, 1-methyldecyl group, 2-methyldecyl group, 3-methyldecyl group, 4-methyldecyl group, 5-methyldecyl group, 6-methyldecyl group, 7-methyldecyl group, 8-methyldecyl group, 9-methyldecyl group, 1,1-dimethylnonyl group, 1,2-dimethylnonyl group group, 1,3-dimethylnonyl group, 1,4-dimethylnonyl group, 1,5-dimethylnonyl group, 1,6-dimethylnonyl group, 1,7-dimethylnonyl group, 1,8-dimethylnonyl group, 1-ethylnonyl group, 2-ethylnonyl group, 1-methylundecyl group, 2-methylundecyl group, 3-methylundecyl group, 4-methylundecyl group, 5-methylundecyl group, 6-methylundecyl group group, 7-methylundecyl group, 8-methylundecyl group, 9-methylundecyl group, 10-methylundecyl group, 1,1-dimethyldecyl group, 1,2-dimethyldecyl group, 1,3-Dimethyldecyl group, 1,4-dimethyldecyl group, 1,5-dimethyldecyl group, 1,6-dimethyldecyl group, 1,7-dimethyldecyl group, 1,8-dimethyldecyl group, 1,9-dimethyldecyl group group, 1-ethyldecyl group, 2-ethyldecyl group, etc. Among these, 2-ethylhexyl group is particularly preferred.
(a22) Ester compound in which R² is a branched alkyl group having 13 to 36 carbon atoms

Examples of branched alkyl groups having 13 to 36 carbon atoms include 1-alkylalkyl groups [1-methyldodecyl group, 1-butyleicosyl group, 1-hexyloctadecyl group, 1-octylhexadecyl group, 1-decyltetradecyl group, 1-undecyltridecyl group, etc.], 2-alkylalkyl group [2-methyldodecyl group, 2-hexyloctadecyl group, 2-octylhexadecyl group, 2-decyltetradecyl group, 2-undecyltridecyl group, 2-dodecylhexadecyl group, 2-tridecylpentadecyl group, 2-decyl octadecyl group, 2-tetradecyl octadecyl group, 2-hexadecyl octadecyl group, 2-tetradecyl eicosyl group, 2-hexadecyl eicosyl group groups], 3-34-alkylalkyl groups (3-alkylalkyl group, 4-alkylalkyl group, 5-alkylalkyl group, 32-alkylalkyl group, 33-alkylalkyl group, 34-alkylalkyl group, etc.), or mixed alkyl groups containing one or more branched alkyl groups, such as the residue of an oxo alcohol with the hydroxyl group removed, wherein the oxo alcohol is obtained from Propylene oligomer (7-11 mer), ethylene/propylene (molar ratio 16/1-1/11) oligomer, isobutylene oligomer (7-8 mer), and α-olefin (5-20 carbon atoms) oligomer (4-octamer) and the like.

The coating resin may contain, as the acrylic monomer (a), an ester compound (a3) consisting of a monovalent aliphatic alcohol with 1 to 3 carbon atoms and (meth)acrylic acid. Examples of the monovalent aliphatic alcohol with 1 to 3 carbon atoms constituting the ester compound (a3) include methanol, ethanol, 1-propanol, and 2-propanol. It is noted that (meth)acrylic acid means acrylic acid or methacrylic acid.

The coating resin is preferably a polymer of a monomer composition containing acrylic acid (a0) and at least one of monomer (a1), monomer (a2), and ester compound (a3). More preferably, the coating resin is a polymer of a monomer composition containing acrylic acid (a0) and at least one of a monomer (a1), an ester compound (a21), and an ester compound (a3). Further preferably, the coating resin is a polymer of a monomer composition containing acrylic acid (a0) and any one of monomer (a1), monomer (a2), and ester compound (a3). Most preferably, the coating resin is a polymer of a monomer composition comprising acrylic acid (a0) and any one of a monomer (a1), an ester compound (a21), and an ester compound (a3).

As the coating resin, examples include a copolymer of acrylic acid and maleic acid using maleic acid as the monomer (a1), a copolymer of acrylic acid and 2-ethylhexyl methacrylate using 2-ethylhexyl methacrylate as the monomer (a2), a copolymer of acrylic acid and methyl methacrylate using methyl methacrylate as the ester compound (a3).

From the point of suppressing volume change of anode active material particles, the total content of monomer (a1), monomer (a2) and ester compound (a3) is preferably 2.0 to 9.9 wt %, more preferably 2.5 to 7.0 wt % based on the weight of the entire monomer.

Preferably, the coating resin does not contain, as the acrylic monomer (a), a salt (a4) of an anionic monomer having a polymerizable unsaturated double bond and an anionic group.

The structure having the polymerizable unsaturated double bond include a vinyl group, an allyl group, a styrenyl group, and a (meth)acryloyl group. Examples of the anionic group include a sulfonic acid group and a carboxyl group. An anionic monomer having a polymerizable unsaturated double bond and an anionic group is a compound obtained by a combination of these. Examples include vinylsulfonic acid, allylsulfonic acid, styrenesulfonic acid and (meth)acrylic acid. Herein, a (meth)acryloyl group means an acryloyl group or a methacryloyl group. Examples of the cations constituting the anionic monomer salt (a4) include lithium ions, sodium ions, potassium ions, and ammonium ions.

In addition, within the range of its physical properties, the coating resin may contain, as the acrylic monomer (a), a radically polymerizable monomer (a5) that is copolymerizable with acrylic acid (a0), monomer (a1), monomer (a2), and ester compound (a3). The radically polymerizable monomer (a5) is preferably a monomer that does not contain active hydrogen, and the following monomers (a51) to (a58) can be used.
(a51) Hydrocarbyl (meth)acrylate constituting (meth)acrylic acid and one of straight chain aliphatic monool having 13 to 20 carbon atoms, alicyclic monool having 5 to 20 carbon atoms, or aromatic aliphatic monool having 7 to 20 carbon atoms. The monools include (i) straight chain aliphatic monools (tridecyl alcohol, myristyl alcohol, pentadecyl alcohol, cetyl alcohol, heptadecyl alcohol, stearyl alcohol, nonadecyl alcohol, arachidyl alcohol, etc.), (ii) alicyclic monools (cyclopentyl alcohol, cyclohexyl alcohol, cycloheptyl alcohol, cyclooctyl alcohol, etc.), (iii) aromatic aliphatic monools (benzyl alcohol, etc.), and mixtures of two or more thereof.
(a52) Poly(n=2-30) oxyalkylene (2-4 carbon atoms) alkyl (1-18 carbon atoms) ether (meth)acrylate [10 mole adduct (meth)acrylate of ethylene oxide (hereinafter abbreviated as EO) to methanol, 10 mole adduct (meth)acrylate of propylene oxide (hereinafter abbreviated as PO) to methanol, etc.]
(a53) Nitrogen-containing vinyl compound
(a53-1) Vinyl compound containing amide group
(i) (meth)acrylamide compounds having 3 to 30 carbon atoms, such as N,N-dialkyl (1 to 6 carbon atoms) or diallkyl (7 to 15 carbon atoms) (meth)acrylamide (N,N-dimethylacrylamide, N, N-dibenzylacrylamide, etc.), diacetone acrylamide
(ii) Vinyl compounds containing an amide group having 4 to 20 carbon atoms, excluding the above (meth)acrylamide compounds, such as N-methyl-N-vinylacetamide, cyclic amide [pyrrolidone compounds (having 6 to 13 carbon atoms, such as N-vinylpyrrolidone, etc.)]
(a53-2) (meth)acrylate compound
(i) Dialkyl (1 to 4 carbon atoms) aminoalkyl (1 to 4 carbon atoms) (meth)acrylate [N,N-dimethylaminoethyl(meth)acrylate, N,N-diethylaminoethyl(meth)acrylate, t-Butylaminoethyl(meth)acrylate, morpholinoethyl(meth)acrylate, etc.]
(ii) (meth)acrylate containing quaternary ammonium group{(meth)acrylate containing tertiary amino group[N,N-dimethylaminoethyl(meth)acrylate, N,N-diethylaminoethyl(meth)acrylate, etc.] quaternized compounds (quaternized using a quaternizing agent such as methyl chloride, dimethyl sulfate, benzyl chloride, dimethyl carbonate, etc.), etc.}
(a53-3) Vinyl compound containing heterocycle

Pyridine compounds (7 to 14 carbon atoms, e.g. 2- or 4-vinylpyridine), imidazole compounds (5 to 12 carbon atoms, e.g. N-vinylimidazole), pyrrole compounds (6 to 13 carbon atoms, e.g. N-vinylpyrrole), pyrrolidone compound (6 to 13 carbon atoms, e.g. N-vinyl-2-pyrrolidone)
(a53-4) Vinyl compound containing nitrile groups

Vinyl compound containing nitrile groups having 3 to 15 carbon atoms, such as (meth)acrylonitrile, cyanostyrene, cyanoalkyl (1 to 4 carbon atoms) acrylates
(a53-5) Vinyl compound containing other nitrogen

Vinyl compound containing nitro group (8 to 16 carbon atoms, such as nitrostyrene), etc.
(a54) Vinyl hydrocarbon
(a54-1) Aliphatic vinyl hydrocarbon

Olefins having 2 to 18 carbon atoms or more (ethylene, propylene, butene, isobutylene, pentene, heptene, diisobutylene, octene, dodecene, octadecene, etc.), dienes having 4 to 10 carbon atoms or more (butadiene, isoprene, 1,4-pentadiene, 1,5-hexadiene, 1,7-octadiene, etc.) etc.
(a54-2) Alicyclic vinyl hydrocarbon

Cyclic unsaturated compounds having from 4 to 18 carbon atoms or more, such as cycloalkenes (e.g. cyclohexene), (di)cycloalkadienes [e.g. (di)cyclopentadiene], terpenes (e.g. pinene and limonene), indenes
(a54-3) Aromatic vinyl hydrocarbon

Aromatic unsaturated compounds having 8 to 20 carbon atoms or more, such as styrene, α-methylstyrene, vinyltoluene, 2,4-dimethylstyrene, ethylstyrene, isopropylstyrene, butylstyrene, phenylstyrene, cyclohexylstyrene, benzylstyrene
(a55) Vinyl ester

Aliphatic vinyl esters [4 to 15 carbon atoms, such as alkenyl esters of aliphatic carboxylic acids (mono- or dicarboxylic acids) (such as vinyl acetate, vinyl propionate, vinyl butyrate, diallyl adipate, isopropenyl acetate, vinyl methoxy acetate)]

Aromatic vinyl esters [9 to 20 carbon atoms, such as alkenyl esters of aromatic carboxylic acids (mono- or dicarboxylic acids) (such as vinyl benzoate, diallyl phthalate, methyl-4-vinyl benzoate), aromatic ring-containing aliphatic carboxylic acids ester (e.g. acetoxystyrene)]
(a56) Vinyl ether

Aliphatic vinyl ethers [3 to 15 carbon atoms, such as vinyl alkyl (1 to 10 carbon atoms) ethers (vinyl methyl ether, vinyl butyl ether, vinyl 2-ethylhexyl ether, etc.), vinyl alkoxy (1 to 6 carbon atoms) alkyl (carbon atoms 1-4) Ethers (vinyl-2-methoxyethyl ether, methoxybutadiene, 3,4-dihydro-1,2-pyran, 2-butoxy-2′-vinyloxydiethyl ether, vinyl-2-ethylmercaptoethyl ether, etc.)), poly(2-4) (meth)allyloxyalkane (carbon number 2-6) (diallyloxyethane, triallyloxyethane, tetraallyloxybutane, tetramethallyloxyethane, etc.)], aromatic vinyl ether (8 to 20 carbon atoms, e.g. vinyl phenyl ether, phenoxystyrene)
(a57) Vinyl ketone

Aliphatic vinyl ketones (4 to 25 carbon atoms, e.g. vinyl methyl ketone, vinyl ethyl ketone), aromatic vinyl ketones (9 to 21 carbon atoms, e.g. vinyl phenyl ketone)
(a58) unsaturated dicarboxylic acid diester unsaturated

Dicarboxylic acid diester having 4 to 34 carbon atoms, for example, dialkyl fumarate (two alkyl groups are linear, branched or alicyclic groups having 1 to 22 carbon atoms), dialkyl maleate (two alkyl groups are linear, branched or alicyclic groups having 1 to 22 carbon atoms)

When the radically polymerizable monomer (a5) is contained, the content thereof based on the weight of all monomers is preferably 0.1 to 3.0 wt %.

A preferable lower limit of the weight average molecular weight of coating resin is 3,000, a more preferable lower limit is 5,000, and a still more preferable lower limit is 7,000. On the other hand, a preferable upper limit of the weight average molecular weight of coating resin is 100,000, and a more preferable upper limit is 70,000.

The weight average molecular weight of the coating layer can be obtained by gel permeation chromatography (hereinafter abbreviated as GPC) measurement under the following conditions.

Device: Alliance GPC V2000 (commercially available from Waters)
Solvent: ortho-dichlorobenzene, DMF, THF
Standard substance: polystyrene
Sample concentration: 3 mg/ml
Column stationary phase: PLgel 10 μm, MIXED-B 2 columns in series (commercially available from Polymer Laboratories Ltd.)
Column temperature: 135° C.

The coating layer can be produced using a known polymerization initiator {azo initiator [2,2′-azobis(2-methylpropionitrile), 2,2′-azobis(2,4-dimethylvaleronitrile), 2,2′-azobis(2-methylbutyronitrile), etc.], peroxide initiator (benzoyl peroxide, di-t-butyl peroxide, lauryl peroxide, etc.) or the like} by a known polymerization method (bulk polymerization, solution polymerization, emulsion polymerization, suspension polymerization, etc.). In order to adjust the weight-average molecular weight to be within a preferable range, the amount of the polymerization initiator used based on the total weight of the monomers is preferably 0.01 to 5 wt %, more preferably 0.05 to 2 wt %, and still more preferably 0.1 to 1.5 wt %, and the polymerization temperature and the polymerization time are adjusted depending on the type of the polymerization initiator and the like, and polymerization is performed at a polymerization temperature of preferably −5 to 150° C., (more preferably 30 to 120° C.) for a reaction time of preferably 0.1 to 50 hours (more preferably 2 to 24 hours).

Examples of solvents used in the solution polymerization include esters (with 2 to 8 carbon atoms, for example, ethyl acetate and butyl acetate), alcohols (with 1 to 8 carbon atoms, for example, methanol, ethanol and octanol), hydrocarbons (with 4 to 8 carbon atoms, for example, n-butane, cyclohexane and toluene), amides (for example, N,N-dimethylformamide (hereafter abbreviated as DMF)) and ketones (with 3 to 9 carbon atoms, for example, methyl ethyl ketone), and in order to adjust the weight-average molecular weight to be within a preferable range, the amount thereof used based on the total weight of the monomers is preferably 5 to 900 wt %, more preferably 10 to 400 wt %, and still more preferably 30 to 300 wt %, and the monomer concentration is preferably 10 to 95 wt %, more preferably 20 to 90 wt %, and still more preferably 30 to 80 wt %.

Examples of dispersion media for emulsion polymerization and suspension polymerization include water, alcohols (for example, ethanol), esters (for example, ethyl propionate), and light naphtha, and examples of emulsifiers include (C10-C24) higher fatty acid metal salts (for example, sodium oleate and sodium stearate), (C10-C24) higher alcohol sulfate metal salts (for example, sodium lauryl sulfate), ethoxylated tetramethyldecynediol, sodium sulfoethyl methacrylate, and dimethylaminomethyl methacrylate. In addition, polyvinyl alcohol, polyvinylpyrrolidone or the like may be added as the stabilizer. The monomer concentration of the solution or dispersion liquid is preferably 5 to 95 wt %, more preferably 10 to 90 wt %, and still more preferably 15 to 85 wt %, and the amount of the polymerization initiator used based on the total weight of the monomers is preferably 0.01 to 5 wt %, and more preferably 0.05 to 2 wt %. During polymerization, a known chain transfer agent, for example, a mercapto compound (dodecyl mercaptan, n-butyl mercaptan, etc.) and/or a halogenated hydrocarbon (carbon tetrachloride, carbon tetrabromide, benzyl chloride, etc.), can be used.

The coating resin may be a crosslinked polymer obtained by cross-linking the coating resin with a cross-linking agent (A′) having a reactive functional group that reacts with a carboxyl group {preferably a polyepoxy compound (a′1) [polyglycidyl ether (bisphenol A diglycidyl ether, propylene glycol diglycidyl ether, glycerin triglycidyl ether, etc.), polyglycidylamine (N,N-diglycidylaniline and 1,3-bis(N,N-diglycidylaminomethyl)) and the like] and/or a polyol compound (a′2) (ethylene glycol, etc.)}.

Examples of methods of cross-linking a coating resin using a cross-linking agent (A′) include a method of coating anode active material particles with a coating resin and then performing cross-linking. Specifically, a method in which anode active material particles and a resin solution containing a coating resin are mixed, the solvent is removed to produce coated active material particles, and a solution containing the cross-linking agent (A′) is then mixed with the coated active material particles and heated, and thus the solvent is removed, a cross-linking reaction is caused, and a reaction in which the polymer compound constituting the coating layer is cross-linked with the cross-linking agent (A′) is caused on the surface of anode active material particles may be exemplified. The heating temperature is adjusted depending on the type of the cross-linking agent, and when the polyepoxy compound (a′1) is used as the cross-linking agent, the heating temperature is preferably 70° C. or higher, and when the polyol compound (a′2) is used, the heating temperature is preferably 120° C. or higher.

### (Conductive Assistant)

The conductive assistant is preferably selected from among materials having conductivity. Examples of preferable conductive assistants include metals [aluminum, stainless steel (SUS), silver, gold, copper, titanium, etc.], carbon [graphite, carbon black (acetylene black, ketjen black, furnace black, channel black, thermal lamp black, carbon nanofiber, etc.) and the like], and mixtures thereof. These conductive assistants may be used alone or two or more thereof may be used in combination. In addition, alloys or metal oxides thereof may be used. Among these, in consideration of electrical stability, aluminum, stainless steel, carbon, silver, gold, copper, titanium and mixtures thereof are more preferable, silver, gold, aluminum, stainless steel and carbon are still more preferable, and carbon is particularly preferable. In addition, these conductive assistants may be those obtained by coating a conductive material [preferably, a metal assistant among the above conductive assistants] around a particulate ceramic material or a resin material by plating or the like.

The shape (form) of the conductive assistant is not limited to a particle form, and may be a form other than the particle form, and may be a form that is put into practical use as a so-called fiber-based conductive assistant such as carbon nanofibers and carbon nanotubes.

The average particle size of the conductive assistant is not particularly limited, and in consideration of electrical characteristics of the battery, it is preferably about 0.01 to 10 μm. In this specification, the “particle size of the conductive assistant” is the maximum distance L among the distances between arbitrary two points on the outline of the conductive assistant. As the value of “average particle size”, the value calculated as an average value of the particle sizes of the particles observed in several to several tens of fields of view using an observation device such as a scanning electron microscope (SEM) or a transmission electron microscope (TEM) is used.

The ratio between the coating resin and the conductive assistant is not particularly limited, and in consideration of the internal resistance of the battery and the like, the weight ratio between the polymer compound constituting the coating layer (resin solid content weight):the conductive assistant is preferably 1:0.01 to 1:50 and more preferably 1:0.2 to 1:3.0.

### <Production Method of Coated Electrode Active Material Particles for Lithium-Ion Batteries>

The production method of coated electrode active material particles for lithium-ion batteries of this invention includes a process in which electrode active material particles, polymer particles with lithium-ion conductivity, a coating resin, a conductive assistant, and an organic solvent are mixed and the solvent is then removed.

The organic solvent is not particularly limited as long as it is an organic solvent that can dissolve a coating resin, and a known organic solvent can be appropriately selected and used.

In the production method of coated electrode active material particles for lithium-ion batteries, first, the electrode active material particles, the polymer particles with lithium-ion conductivity, the coating resin, and the conductive assistant are mixed in an organic solvent. The order, in which the electrode active material particles, particles consisting of a polymer having lithium-ion conductivity, coating resin, and conductive assistant are mixed, is not particularly limited. For example, a resin composition consisting of a coating resin, particles of a polymer having lithium-ion conductivity, and a conductive assistant mixed in advance may be further mixed with the electrode active material particles. The electrode active material particles, the particles made of polymer having lithium-ion conductivity, and the conductive assistant may be mixed at the same time. The coating resin may be mixed with the electrode active material particles, and particles made of polymer having lithium-ion conductivity and a conductive assistant may be further mixed.

The above coated electrode active material particles for lithium-ion batteries can be obtained by covering electrode active material particles with a coating layer containing a coating resin, particles made of polymer having lithium-ion conductivity and a conductive assistant, for example, while the electrode active material particles are put into a universal mixer and stirred at 30 to 500 rpm, the particles can be obtained when a coating resin is added dropwise over 1 to 90 minutes and mixed, the particles made of polymer having lithium-ion conductivity and the conductive assistant are mixed, the temperature is raised to 50 to 200° C. with stirring, the pressure is reduced to 0.007 to 0.04 MPa, the sample is then left for 10 to 150 minutes, and the solvent is removed.

The mixing ratio of the electrode active material particles, and the resin composition containing the particles made of polymer having lithium-ion conductivity, the coating resin and the conductive assistant is not particularly limited, and the weight ratio of the electrode active material particles:the resin composition is preferably 1:0.001 to 0.1.

From the viewpoint of cycle characteristics, the coverage of the coated electrode active material particles for lithium-ion batteries of the present invention is preferably 30 to 95% as obtained by the following calculation formula.

coverage (%)={1−[BET specific surface area of coated active material particles/(BET specific surface area of electrode active material×weight proportion of electrode active material contained in coated electrode active material particles+BET specific surface area of particles made of polymer having lithium-ion conductivity×weight proportion of particles made of polymer having lithium-ion conductivity contained in coated electrode active material particles+BET specific surface area of conductive assistant×weight proportion of conductive assistant contained in coated electrode active material particles)]}×100

### <Electrode for Lithium-Ion Batteries>

The electrode for lithium-ion batteries of the present invention is an electrode for lithium-ion batteries comprising an electrode active material layer containing the coated electrode active material particles for lithium-ion batteries of the present invention and an electrolytic solution containing an electrolyte and a solvent, wherein the weight proportion of a coating resin contained in the electrode for lithium-ion batteries is 1 to 10 wt % based on the weight of the electrode for lithium-ion batteries.

### (Electrode Active Material Layer)

The electrode for lithium-ion batteries of the present invention includes an electrode active material layer containing the coated electrode active material particles for lithium-ion batteries of the present invention and an electrolytic solution containing an electrolyte and a solvent.

The coated electrode active material particles for lithium-ion batteries include coated cathode active material particles and coated anode active material particles, and can be appropriately selected depending on whether they are used as a cathode or an anode.

In terms of the coated electrode active material particles for lithium-ion batteries, the weight proportion of the coating resin contained in the electrode for lithium-ion batteries is preferably 1 to 10 wt % based on the weight of the electrode for lithium-ion batteries from the viewpoint of formability, mechanical strength and energy density of electrodes for lithium-ion batteries. In a case when the coated electrode active material particles for lithium-ion batteries are the coated cathode active material particles for lithium-ion batteries, the weight proportion of the coating resin contained in the cathode for lithium-ion batteries is preferably 1 to 5 wt % based on the weight of the cathode for lithium-ion batteries. In a case when the coated electrode active material particles for lithium-ion batteries are the coated anode active material particles for lithium-ion batteries, the weight proportion of the coating resin contained in the anode for lithium-ion batteries is preferably 1 to 5 wt % based on the weight of the anode for lithium-ion batteries.

As the electrolyte, electrolytes used in known electrolytic solutions can be used, and for example, lithium salts of inorganic anions such as LiPF₆, LiBF₄, LiSbF₆, LiAsF₆, LiClO₄ and LiN(FSO₂)₂, and lithium salts of organic anions such as LiN(CF₃SO₂)₂, LiN(C₂F₅SO₂)₂ and LiC(CF₃SO₂)₃ may be exemplified. Among these, LiN(FSO₂)₂ is preferable in consideration of the battery output and charging and discharging cycle characteristics.

As the solvent, non-aqueous solvents used in known electrolytic solutions can be used, and for example, lactone compounds, cyclic or chain carbonates, chain carboxylates, cyclic or chain ethers, phosphate esters, nitrile compounds, amide compounds, sulfone, sulfolane and mixtures thereof can be used.

Examples of lactone compounds include 5-membered ring (γ-butyrolactone, γ-valerolactone, etc.) and 6-membered ring (5-valerolactone, etc.) lactone compounds.

Examples of cyclic carbonates include propylene carbonate, ethylene carbonate (EC) and butylene carbonate (BC).

Examples of chain carbonates include dimethyl carbonate (DMC), methyl ethyl carbonate (MEC), diethyl carbonate (DEC), methyl-n-propyl carbonate, ethyl-n-propyl carbonate and di-n-propyl carbonate.

Examples of chain carboxylates include methyl acetate, ethyl acetate, propyl acetate and methyl propionate.

Examples of cyclic ethers include tetrahydrofuran, tetrahydropyran, 1,3-dioxolane and 1,4-dioxane. Examples of chain ethers include dimethoxymethane and 1,2-dimethoxyethane.

Examples of phosphate esters include trimethyl phosphate, triethyl phosphate, ethyldimethyl phosphate, diethylmethyl phosphate, tripropyl phosphate, tributyl phosphate, tri(trifluoromethyl) phosphate, tri(trichloromethyl) phosphate, tri(trifluoroethyl) phosphate, tri(triperfluoroethyl) phosphate, 2-ethoxy-1,3,2-dioxaphospholan-2-one, 2-trifluoroethoxy-1,3,2-dioxaphospholan-2-one and 2-methoxyethoxy-1,3,2-dioxaphospholan-2-one.

Examples of nitrile compounds include acetonitrile. Examples of amide compounds include DMF. Examples of sulfones include dimethyl sulfone and diethyl sulfone.

These solvents may be used alone or two or more thereof may be used in combination.

The concentration of the electrolyte in the electrolytic solution is preferably 1.2 to 5.0 mol/L, more preferably 1.5 to 4.5 mol/L, still more preferably 1.8 to 4.0 mol/L, and particularly preferably 2.0 to 3.5 mol/L.

The electrode active material layer may further contain a conductive assistant in addition to the conductive assistant that is contained as necessary in the coating layer of the above coated electrode active material particles. While the conductive assistant that is contained as necessary in the coating layer is integrated with the coated electrode active material particles, the conductive assistant contained in the electrode active material layer can be distinguished in that it is contained separately from the coated electrode active material particles. As the conductive assistant that the electrode active material layer may contain, those described in [Coated electrode active material particles for lithium-ion batteries] can be used.

The electrode active material layer preferably does not contain a binder. Here, in this specification, the binder refers to an agent that cannot reversibly fix the coated electrode active material particles to each other and the coated electrode active material particles to the current collector, and known solvent-drying type binders for lithium ion batteries such as starch, polyvinylidene fluoride, polyvinyl alcohol, carboxymethyl cellulose, polyvinylpyrrolidone, tetrafluoroethylene, styrene-butadiene rubber, polyethylene and polypropylene may be exemplified. These binders are used by being dissolved or dispersed in a solvent, and are solidified by volatilizing and distilling off the solvent to irreversibly fix the coated electrode active material particles to each other and the coated electrode active material particles to the current collector.

The electrode active material layer may contain an adhesive resin. The adhesive resin is a resin that does not solidify and has adhesiveness even if the solvent component is volatilized and dried, and is a material different and distinguished from the binder. In addition, while the coating layer constituting the coated electrode active material particles is fixed to the surface of electrode active material particles, the adhesive resin reversibly fixes the surfaces of the electrode active material particles to each other. The adhesive resin can be easily separated from the surface of electrode active material particles, but the coating layer cannot be easily separated. Therefore, the coating layer and the adhesive resin are different materials.

As the adhesive resin, polymers which contain at least one low Tg monomer selected from the group consisting of vinyl acetate, 2-ethylhexyl acrylate, 2-ethylhexyl methacrylate, butyl acrylate and butyl methacrylate as an essential constituent monomer, and in which the total weight proportion of the low Tg monomers based on the total weight of the constituent monomers is 45 wt % or more may be exemplified. When the adhesive resin is used, it is preferable to use 0.01 to 10 wt % of the adhesive resin based on the total weight of the electrode active material particles.

In consideration of battery performance, the thickness of the electrode active material layer is preferably 150 to 600 μm and more preferably 200 to 450 μn.

### (Current Collector)

It is preferable that the electrode for lithium-ion batteries comprises a current collector, and an electrode active material layer is provided on the surface of the current collector.

Examples of materials constituting the current collector include metal materials such as copper, aluminum, titanium, stainless steel, nickel and alloys thereof, and calcined carbon, conductive polymer materials, and conductive glass. The shape of the current collector is not particularly limited, and a sheet-like current collector made of the above material and a deposition layer including fine particles composed of the above material may be used.

It is preferable that the electrode for lithium-ion batteries include a resin current collector made of a conductive polymer material, and the electrode active material layer be provided on the surface of the resin current collector.

As the conductive polymer material constituting the resin current collector, for example, those obtained by adding a conducting agent to a resin can be used. As the conducting agent constituting the conductive polymer material, the same conductive assistant which is an optional component for the coating layer can be preferably used.

Examples of resins constituting the conductive polymer material include polyethylene (PE), polypropylene (PP), polymethylpentene (PMP), polycycloolefin (PCO), polyethylene terephthalate (PET), polyethernitrile (PEN), polytetrafluoroethylene (PTFE), styrene butadiene rubber (SBR), polyacrylonitrile (PAN), polymethyl acrylate (PMA), polymethyl methacrylate (PMMA), polyvinylidene fluoride (PVdF), epoxy resins, silicone resins and mixtures thereof.

In consideration of electrical stability, polyethylene (PE), polypropylene (PP), polymethylpentene (PMP) and polycycloolefin (PCO) are preferable, and polyethylene (PE), polypropylene (PP) and polymethylpentene (PMP) are more preferable.

The resin current collector can be obtained by known methods described in Japanese Patent Application Publication No. 2012-150905, WO 2015/005116 and the like.

The thickness of the current collector is not particularly limited, but is preferably 5 to 150 μm.

### (Method for Manufacturing an Electrode for Lithium-Ion Batteries)

The electrode for lithium-ion batteries of the present invention can be produced, for example, by applying an electrode active material layer slurry containing the above coated electrode active material particles, an electrolytic solution containing an electrolyte and a solvent, as necessary, a conductive assistant and the like to a current collector and then drying it.

Specifically, a method in which a electrode active material layer slurry is applied onto a current collector using a coating device such as a bar coater, the non-woven fabric is then left on the electrode active material particles to absorb a liquid, and thus the solvent is removed, and as necessary, pressing is performed with a press machine may be exemplified.

Further, for example, a powder (electrode precursor) obtained by mixing the coated electrode active material particles for lithium ion batteries of the present invention and, if necessary, a conductive assistant, etc., can also be produced by pouring the powder into an electrolytic solution after applying the powder to the current collector and pressing it with a press machine to form an electrode active material layer.

In addition, it is fine that the electrode active material layer slurry or the electrode precursor is applied onto a release film and pressed to form an electrode active material layer, and after the electrode active material layer is transferred to a current collector, the electrolyte may be injected.

### <Lithium-Ion Battery>

The electrode for lithium-ion batteries of the present invention can be used as a lithium-ion battery by combining a separator, an electrode for lithium-ion batteries of this invention and an electrode that is a pair therewith.

Although a known electrode can be used as the electrode to be paired with the electrode for lithium-ion batteries of the present invention, the electrode for lithium-ion batteries of the present invention is preferred.

Examples of separators include known separators for lithium ion batteries such as polyethylene or polypropylene porous films, laminated films of a porous polyethylene film and a porous polypropylene, non-woven fabrics composed of synthetic fibers (polyester fibers, aramid fibers, etc.), glass fibers or the like, and those with ceramic fine particles such as silica, alumina, and titania adhered to their surfaces.

Lithium-ion batteries can be produced, for example, by stacking the electrode for lithium-ion batteries of the present invention, a separator, and the electrode to be paired with the electrode for lithium-ion batteries of the present invention in this order, and then using an electrolytic solution as necessary.

### EXAMPLES

Next, the present invention will be described in detail with reference to examples, but the present invention is not limited to the examples as long as it does not depart from the spirit of the present invention. Here, unless otherwise specified, parts means parts by weight, and % means wt %.

### <Particles Made of Polymer Having Lithium-Ion Conductivity>

The following materials were prepared as particles made of polymer having lithium-ion conductivity.
Polyethylene glycol (PEG): PEG-6000P (manufactured by Sanyo Chemical Industries, Ltd.), volume average particle size 106 μm
Polyacrylonitrile (PAN): Polyacrylonitrile powder (manufactured by Goodfellow), volume average particle size 50 μm
Polyethylene oxide (PEO): Alcox (manufactured by Meisei Chemical Industry Co., Ltd.), volume average particle size 1000 μm

Each of the materials prepared as particles made of polymer having lithium-ion conductivity was placed in a disposable cup. And the each was crushed together with a zirconia crushing ball using Awatori Rentaro (registered trademark) [manufactured by Shinky Co., Ltd.] at 1000 rpm and 10 seconds. Thereafter, it was allowed to cool and was crushed again using the Awatori Rentaro at 1000 rpm and 10 seconds. This was repeated six times, and the resulting crushed materials were each classified using a 50 μm sieve. Each material after this classification was used in the following examples as particles made of polymer having lithium-ion conductivity. The volume average particle size after crushing and classification of particles made of polymer having lithium-ion conductivity used in Examples are shown in Table 1 and 2.

<Particles Made of Polymer that does not have Lithium-Ion Conductivity>

The following materials were prepared as particles made of polymer that does not have lithium-ion conductivity.

### (Polyester Resin)

673 parts of a 2-mole adduct of bisphenol A propylene oxide, 15 parts of a 5-mole adduct of propylene oxide of a phenol novolac resin (approximately 5 nuclei), and terephthal. 157 parts of acid, 37 parts of maleic anhydride, 152 parts of dodecenylsuccinic anhydride, and 2 parts of dibutyltin oxide were added in a reaction tank equipped with a cooling tube, a stirrer, and a nitrogen introduction tube. Then, the mixture was reacted for 8 hours at 220° C. under normal pressure, and further reacted for 5 hours under reduced pressure of 0.001 to 0.002 MPa. Next, 32 parts of trimellitic anhydride was added to this and reacted at 180° C. under normal pressure for 2 hours to obtain a polyester resin. The obtained polyester resin was cut into approximately 1 cm×1 cm pieces using scissors, and crushed for 5 minutes using a tablet crusher. The obtained powder was placed in a disposable cup and crushed together with a zirconia crushing ball using Awatori Rentaro at 1000 rpm for 10 seconds. Thereafter, it was allowed to cool and was crushed again using the Awatori Rentaro at 1000 rpm and 10 seconds. This was repeated six times, and the resulting crushed materials were each classified using a 50 μm sieve.

### (Polyacrylic Acid)

Polyacrylic acid [product name: Polyacrylic Acid 5000, manufactured by Fuji Film Wako Pure Chemical Industries, Ltd.] was placed in a disposable cup and crushed together with a zirconia crushing ball at 1000 rpm and 10 seconds using Awatori Rentaro. Thereafter, it was allowed to cool and was crushed again using the Awatori Rentaro at 1000 rpm and 10 seconds. This was repeated six times, and the resulting crushed materials were each classified using a 50 Jim sieve. Each material after this classification was used in the following examples as particles made of polymer that does not have lithium-ion conductivity. The volume average particle size after crushing and classification of particles made of polymer that does not have lithium-ion conductivity used in Comparisons are shown in Table 1 and 2.

### <Preparation of Coating Resin>

65 parts of toluene was charged into a four-necked colben equipped with a stirrer, a thermometer, a reflux condenser, a dropping funnel, and a nitrogen gas introduction tube, and the temperature was raised to 75° C. Next, while stirring a monomer mixture containing 80 parts of lauryl methacrylate, 15 parts of methyl methacrylate, 4.6 parts of methacrylic acid and 0.4 parts of 1,6-hexanediol dimethacrylate with an initiator solution of 0.03 parts of 2,2′-azobis(2,4-dimethylvaleronitrile) dissolved in 5 parts of toluene, radical polymerization was carried out by continuous dropwise addition over 2 hours using a dropping funnel while blowing nitrogen into the four-necked kolben. After the dropwise addition was completed, the temperature was raised to 75° C. and the reaction was continued for 1 hour. Next, an initiator solution in which 0.01 part of 2,2′-azobis(2,4-dimethylvaleronitrile) was dissolved in 1 part of toluene was added through a dropping funnel, and the reaction was continued for an additional 3 hours to obtain a copolymer solution. The obtained copolymer solution was transferred to a Teflon (registered trademark) vat. Toluene was distilled off by drying it under reduced pressure at 80° C. and 0.09 MPa for 3 hours. Next, the temperature was raised to 100° C. for 1 hour, and further heating was performed at 120° C. and 0.01 MPa for 1 hour in a vacuum dryer. Finally, a coating resin was prepared.

### Example 1

### <Preparation of Coated Cathode Active Material Particles for Lithium-Ion Batteries>

One part of the coating resin was dissolved in three parts of toluene to obtain a coating resin solution.

92 parts of cathode active material particles (LiNi_{0.8}Co_{0.15}Al_{0.05}O₂ powder, volume average particle size 4 μm) were placed in a universal mixer high speed mixer FS25 [manufactured by Earth Technica Co., Ltd.], and 12 parts of the coating resin solution were dripped over two minutes and the mixture was further stirred for 5 minutes under the conditions of Room temperature, stirring at 720 rpm.

Next, in a stirred state, 3 parts of acetylene black (Denka Black (registered trademark) manufactured by Denka Co., Ltd.) as a conductive agent and particles made of polymer having lithium ion conductivity (trade name “PEG-6000P” [Sanyo [manufactured by Kasei Kogyo Co., Ltd.]) (1 wt % based on the weight of the coated positive electrode active material particles) was added in portions for 2 minutes, and the stirring was continued for 30 minutes.

Thereafter, the pressure was reduced to 0.01 MPa while stirring was maintained, and then the temperature was raised to 120° C. while maintaining stirring and the reduced degree of pressure. And stirring, vacuum and temperature were maintained for 8 hours to distill off volatile components.

The obtained powder was classified using a sieve with an opening of 200 μm to prepare coated cathode active material particles.

### <Preparing an Electrolytic Solution>

An electrolytic solution was prepared by dissolving LiN(FSO)₂ at a proportion of 2.0 mol/L in a solvent mixture containing ethylene carbonate (EC) and propylene carbonate (PC) (volume ratio of 1:1).

### <Production of Resin Current Collector>

70 parts of polypropylene [product name “SunAllomer PL500A”, commercially available from SunAllomer Ltd.], 25 parts of carbon nanotubes [product name: “FloTube9000”, commercially available from CNano] and 5 parts of a dispersing agent [product name “UMEX 1001”, commercially available from Sanyo Chemical Industries, Ltd.] were melt-kneaded using a twin-screw extruder under conditions of 200° C. and 200 rpm to obtain a resin mixture.

The obtained resin mixture was passed through a T-die extrusion film forming machine and stretched and rolled to obtain a conductive film for a resin current collector having a film thickness of 100 μm. Next, the obtained conductive film for a resin current collector was cut into 4.0 cm×3.0 cm, one side was subjected to nickel vapor deposition and a resin current collector to which a current extraction terminal (5 mm×3 cm) was connected was then obtained.

### <Preparation of Cathode for Lithium-Ion Batteries>

34 parts of the electrolytic solution and 66 parts of the above coated cathode active material particles were mixed for 5 minutes at 2000 rpm using a planetary stirring type mixing and kneading device {Awatori Rentaro [manufactured by Shinky Co., Ltd.]} to produce a cathode active material layer slurry. The obtained cathode active material layer slurry was applied to one side of the resin current collector so that the weight per unit area was 110 mg/cm2 and pressed at a pressure of 62 MPa for about 10 seconds to produce a cathode for lithium-ion batteries with a thickness of 450 μm (15φ). The weight proportion of the coating resin in the produced cathode for lithium-ion batteries was 3 wt % based on the weight of the cathode for lithium-ion batteries.

### <Production of Lithium Ion Battery>

The obtained cathode for lithium-ion batteries was combined with a Li metal counter electrode via a separator (#3501, commercially available from Celgard LLC) to produce a laminate cell.

### Examples 2 to 9, Comparisons 1 to 3

Coated cathode active material particles were produced in the same manner as in Example 1, except that the type and the addition amount of particles made of polymer having lithium-ion conductivity were changed as shown in Table 1.

Thereafter, a cathode for lithium-ion batteries and a lithium-ion battery were produced in the same manner as in Example 1, except that the prepared coated cathode active material particles respectively were used.

In Comparisons 2 and 3, a polyester resin as a polymer that does not have lithium-ion conductivity was used instead of a polymer having lithium-ion conductivity. As shown in the “Type of polymer” column of Table 1, this polyester resin is a polymer that does not have lithium-ion conductivity.

TABLE 1

| | Coated cathode active material particles | | | Cathode for lithium- |
|---|---|---|---|---|
| | | Volume | Addition amount | ion batteries |
| | | Average | based on weight of | Weight proportion of |
| | | Particle | coated cathode active | coating resin in |
| | | Size | material particles | cathode for lithium- |
| | Type of Polymer | (μm) | (wt %) | ion batteries (wt %) |
| Example 1 | PEG | 11 | 1 | 3.00 |
| Example 2 | PEG | 11 | 4 | 2.91 |
| Example 3 | PAN | 38 | 1 | 3.00 |
| Example 4 | PAN | 38 | 4 | 2.91 |
| Example 5 | PEO | 5 | 1 | 3.00 |
| Example 6 | PEO | 5 | 4 | 2.91 |
| Example 7 | PEG | 11 | 7 | 2.81 |
| Example 8 | PAN | 38 | 7 | 2.81 |
| Example 9 | PEO | 5 | 7 | 2.81 |
| Comparison 1 | No addition | — | — | 3.03 |
| Comparison 2 | Polyester resin | 13 | 1 | 3.00 |
| Comparison 3 | Polyester resin | 13 | 4 | 2.91 |

### <Production of Coated Anode Active Material Particles for Lithium-Ion Batteries>

### Example 10

One part of the coating resin was dissolved in three parts of toluene to obtain a coating resin solution. When 80 parts of the anode active material particles (hard carbon powder, a volume average particle size of 25 μm) were put into a Universal Mixer High Speed Mixer FS25 [commercially available from EARTHTECHNICA Co., Ltd.] and stirred at room temperature and 720 rpm, 32 parts of the coating resin solution was added dropwise over 2 minutes and additionally stirred for 5 minutes.

Next, under stirring, 10 parts of acetylene black [Denka Black (registered trademark), commercially available from Denka Co., Ltd.] as a conductive assistant, 1 part of Carbon nanofiber [manufactured by Teijin Ltd.], and 1 part of particles made of polymer with lithium-ion conductivity (product name: “PEG-6000P” [manufactured by Sanyo Chemical Industries, Ltd.]) (1 wt % based on the weight of coated anode active material particles) were added over 2 minutes in a divided manner, and stirring was continued for 30 minutes.

Then, the pressure was reduced to 0.01 MPa while stirring was maintained, the temperature was then raised to 140° C. while stirring and the degree of pressure reduction were maintained, and volatile components were distilled off while stirring, the degree of pressure reduction and the temperature were maintained for 8 hours.

The obtained powder was classified with a sieve with an opening of 200 μm to obtain coated anode active material particles.

### <Production of Anode for Lithium-Ion Batteries>

49 parts of an electrolytic solution and 51 parts of the coated anode active material particles were mixed using a planetary stirring type mixing and kneading device {Awatori Rentaro [commercially available from Thinky Corporation]} at 2,000 rpm for 5 minutes and mixed to produce an anode active material layer slurry.

The obtained anode active material layer slurry was applied to one side of the resin current collector so that the weight per unit area was 59 mg/cm² and pressed at a pressure of 1.4 MPa for about 10 seconds to produce an anode for lithium-ion batteries (16φ) having a thickness of 600 μm.

The weight proportion of the coating resin in the produced anode for lithium-ion batteries was 8 wt % based on the weight of the anode for lithium-ion batteries.

### <Production of Lithium Ion Battery>

The obtained anode for lithium-ion batteries was combined with a Cu metal counter electrode via a separator (#3501, commercially available from Celgard LLC) to produce a laminate cell.

### Examples 11 to 18, Comparisons 4 to 6

Coated cathode active material particles were produced in the same manner as in Example 10, except that the type and the addition amount of particles made of polymer having lithium-ion conductivity were changed as shown in Table 2.

Thereafter, a cathode for lithium-ion batteries and a lithium-ion battery were produced in the same manner as in Example 10, except that the prepared coated anode active material particles respectively were used.

In Comparisons 5 and 6, a polyacrylic acid as a polymer that does not have lithium-ion conductivity was used instead of a polymer having lithium-ion conductivity. As shown in the “Type of polymer” column of Table 2, this polyacrylic acid is a polymer that does not have lithium-ion conductivity.

TABLE 2

| | Coated cathode active material particles | | | Anode for lithium- |
|---|---|---|---|---|
| | | Volume | Addition amount | ion batteries |
| | | Average | based on weight of | Weight proportion of |
| | | Particle | coated anode active | coating resin in |
| | | Size | material particles | anode for lithium- |
| | Type of Polymer | (μm) | (wt %) | ion batteries (wt %) |
| Example 10 | PEG | 11 | 1 | 8.00 |
| Example 11 | PEG | 11 | 4 | 7.76 |
| Example 12 | PAN | 38 | 1 | 8.00 |
| Example 13 | PAN | 38 | 4 | 7.76 |
| Example 14 | PEO | 5 | 1 | 8.00 |
| Example 15 | PEO | 5 | 4 | 7.76 |
| Example 16 | PEG | 11 | 7 | 7.51 |
| Example 17 | PAN | 38 | 7 | 7.51 |
| Example 18 | PEO | 5 | 7 | 7.51 |
| Comparison 4 | No addition | — | — | 8.1 |
| Comparison 5 | Polyacrylic Acid | 12 | 1 | 8.00 |
| Comparison 6 | Polyacrylic Acid | 12 | 4 | 7.76 |

### <Measurement of Internal Resistance Value>

The lithium-ion batteries obtained in each example and comparison were charged and discharged once at 25° C. Thereafter, it was fully charged and stored in a condition of 60° C.

Using an impedance measuring device (chemical impedance analyzer IM3590, commercially available from HIOKI E.E. Corporation), after 0 days (immediately after full charge), after storage for 7 days and after storage for 14 days, the internal resistance value at a frequency of 1,000 Hz was measured.

In addition, the difference of the internal resistance values between after 0 days (immediately after full charge) and after 14 days of storage (internal resistance value on 14th day−internal resistance value after 0 days) was determined.

The results are shown in Table 3.

TABLE 3

| | | | | Difference in internal |
|---|---|---|---|---|
| | | | | resistance value |
| | Internal resistance value (Ω) | | | between after 0 days |
| | Storage days (day) | | | and after storage |
| | 0 | 7 | 14 | after 14 days (Ω) |
| Example 1 | 2.97 | 3.87 | 5.13 | 2.16 |
| Example 2 | 2.79 | 3.75 | 5.15 | 2.36 |
| Example 3 | 3.21 | 3.97 | 5.32 | 2.11 |
| Example 4 | 2.82 | 3.78 | 5.08 | 2.26 |
| Example 5 | 3.18 | 4.01 | 5.48 | 2.30 |
| Example 6 | 2.83 | 3.93 | 5.25 | 2.42 |
| Example 7 | 4.52 | 5.43 | 6.72 | 2.20 |
| Example 8 | 4.38 | 5.40 | 6.73 | 2.35 |
| Example 9 | 4.49 | 5.56 | 6.89 | 2.40 |
| Comparison 1 | 4.31 | 5.28 | 7.35 | 3.04 |
| Comparison 2 | 3.73 | 5.05 | 6.42 | 2.69 |
| Comparison 3 | 4.62 | 5.97 | 7.20 | 2.58 |
| Example 10 | 3.02 | 3.83 | 4.23 | 1.21 |
| Example 11 | 2.89 | 3.79 | 4.14 | 1.25 |
| Example 12 | 3.29 | 3.81 | 4.34 | 1.05 |
| Example 13 | 2.78 | 3.86 | 4.11 | 1.33 |
| Example 14 | 3.27 | 3.93 | 4.24 | 0.97 |
| Example 15 | 2.83 | 3.89 | 4.41 | 1.58 |
| Example 16 | 4.32 | 5.00 | 5.82 | 1.50 |
| Example 17 | 4.22 | 5.04 | 5.89 | 1.67 |
| Example 18 | 4.48 | 5.09 | 5.92 | 1.44 |
| Comparison 4 | 4.25 | 5.18 | 7.42 | 3.17 |
| Comparison 5 | 3.58 | 4.78 | 6.12 | 2.54 |
| Comparison 6 | 4.53 | 5.60 | 6.81 | 2.28 |

By comparing Examples 1 to 9 with Comparisons 1 to 3, it is confirmed that the lithium-ion batteries, which use the coated electrode active material particles for lithium-ion batteries of this invention as a coated cathode material particles for lithium-ion batteries, can prevent the internal resistance value of the lithium ion battery from increasing even when they are stored in a high temperature environment for a long period of time.

By comparing Examples 10 to 18 with Comparisons 4 to 6, it is confirmed that the lithium-ion batteries, which use the coated electrode active material particles for lithium-ion batteries of this invention as a coated anode material particles for lithium-ion batteries, can prevent the internal resistance value of the lithium ion battery from increasing even when they are stored in a high temperature environment for a long period of time.

### INDUSTRIAL APPLICABILITY

The coated electrode active material particles for lithium-ion batteries of the present invention can be widely used in various applications as coated electrode active material particles for lithium-ion batteries, since said particles can prevent the internal resistance value of the lithium-ion battery from increasing even when the particles are used in a high temperature environment.

1. Coated electrode active material particles for lithium-ion batteries in which at least a part of the surface of the electrode active material particles is coated with a coating layer,
wherein the coating layer contains particles made of polymer having lithium-ion conductivity, a coating resin, and a conductive assistant.

2. The coated electrode active material particles for lithium-ion batteries according to claim 1,
wherein the polymer having lithium-ion conductivity is one or more selected from the group consisting of polyethylene oxide, polyacrylonitrile, and polyethylene glycol.

3. The coated electrode active material particles for lithium-ion batteries according to claim 1,
wherein the volume average particle size of the particles made of polymer having lithium-ion conductivity is 1 to 50 μm.

4. The coated electrode active material particles for lithium-ion batteries according to claim 1,
wherein the weight proportion of the particles made of polymer having lithium-ion conductivity is 0.1 to 5 wt % based on the weight of the coated electrode active material particles.

5. An electrode for lithium-ion batteries comprising an electrode active material layer containing the coated electrode active material particles for lithium-ion batteries of claim 1 and an electrolytic solution containing an electrolyte and a solvent,
wherein the weight proportion of a coating resin contained in the electrode for lithium-ion batteries is 1 to 10 wt % based on the weight of the electrode for lithium-ion batteries.

6. A production method of coated electrode active material particles for lithium-ion batteries,
wherein the coated electrode active material particles for lithium-ion batteries are mentioned in claim 1,
the production method including:
a step of removing a solvent after mixing electrode active material particles, particles made of polymer having lithium-ion conductivity, a coating resin, a conductive assistant, and an organic solvent.
